(19) United States
(12) Patent Application Publication
(10) Pub. No.: US 2005/0228718 A1
(43) Pub. Date: Oct. 13, 2005

(54) Point of purchase research device

(75) Inventor: Andrew Austin, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: POP INSIGHTS INC., Chicago, IL (US)

(21) Appl. No.: 10/823,133

(22) Filed: Apr. 13, 2004

(51) Int. Cl. G06F 17/60; H04N 7/16

(52) U.S. Cl. 705/14

(57) ABSTRACT

A point of purchase research device includes a housing having a user surface and a mounting surface adapted to cooperate with a store shelf. The housing further includes a display device affixed adjacent to the user surface and communicatively connected to a user input device and a control unit. The control unit having a processor communicatively connected to the display device and the user input device. The control unit executes a control routine on the processor and is configured to control the display device to gather consumer information from the user input device.

### TECHNICAL FIELD

The present disclosure is generally directed to retail marketing devices, and more particularly to a device and method for interactively researching and gathering consumer information at the retail shelf point of purchase.

### BACKGROUND

The sale and marketing of products and packaging typically involve a great deal of time and money to maximize consumer impact and desirability. Specifically, product packaging, placement and merchandising have been shown to have a large impact on the sales and ultimately the success of retail goods. Therefore, a great deal of time is dedicated to designing and promoting product packages, retail signage, and retail displays that catch a consumer's eye and raise her interest level.

A known system for providing information to consumers is disclosed in U.S. Pat. No. 6,434,530, titled “Interactive Shopping System with Mobile Apparatus.”The patent discloses an interactive system having an interactive and intelligent source of information, for example supplemental information related to articles available for selection by shoppers in a shopping venue, and not otherwise available to the shoppers during shopping. The interactive system includes a plurality of interactive, mobile apparatus that shoppers can move throughout the shopping venue to transmit queries to and receive information from the interactive source of information when making article selection decisions. Further, at least some of the received information can be formulated specifically to influence the article selection decisions. An artificial intelligence unit can evaluate the queries and select information for inclusion in responses to the queries. However, this device does not gather customer specific market research information relating to point of purchase attitudes, preferences, decisions, or products. Further, this device does not encourage customers to voice their attitudes and opinions using a reward or incentive system of any kind.

Accordingly, a device and method for interactively researching and gathering consumer information at the point of purchase is needed to address the shortcomings of the known shopping system discussed above. Specifically, a device and method for interactively gathering consumer information in response to a customized survey is needed.

### SUMMARY

A point of purchase research device includes a housing having a user surface and a mounting surface adapted to cooperate with a store shelf. The housing further includes a display device affixed adjacent to the user surface and communicatively connected to a user input device and a control unit. The control unit having a processor communicatively connected to the display device and the user input device. The control unit executes a control routine on the processor and is configured to control the display device to gather consumer information from the user input device.

### BRIEF DESCRIPTION OF THE DRAWINGS

For a more complete understanding of the disclosed method and device, reference should be made to the following detailed description and accompanying drawings wherein:

FIG. 1 illustrates a front view of an exemplary research device;

FIG. 2 illustrates a perspective view of the exemplary research device of FIG. 1 positioned adjacent to a shelf edge;

FIG. 3 illustrates an operational flowchart of one exemplary research process;

FIG. 4 illustrates a system level diagram of an exemplary market research system; and

FIG. 5 illustrates a flowchart showing a data flow path of the system of FIG. 5.

### DETAILED DESCRIPTION

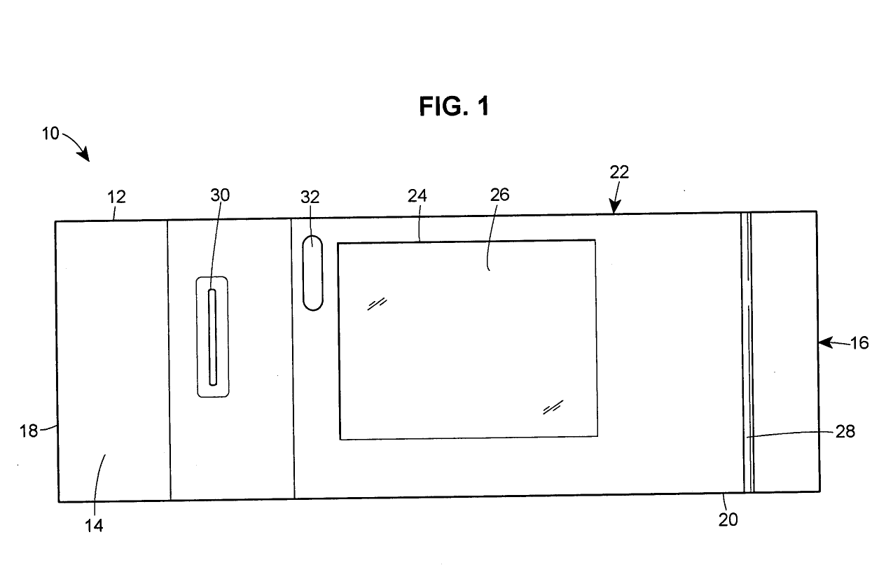

Referring to FIG. 1, a point-of-purchase (POP) research device is generally illustrated by the reference numeral 10. The research device 10 includes a housing 12 having a front surface 14, a first end 16, a second end 18, a bottom edge 20, and a top edge 22. The housing 12 may be manufactured, for example, from an aluminum material such as AL6160 and painted or anodized a variety of colors such as red, yellow, or orange to attract consumer attention. It will be understood that the housing 12 may be molded from a plastic material such as high density polyetheylene (HDPE) or made from any other suitable material. If the housing 12 is to be molded, a single stage or multiple stage mold can be manufactured to produce the housing 12 having a customizable cavity to accept any desired components of research device 10. The top edge 22, bottom edge 20, first end 16, and second end 18 may be adapted to cooperate with a placard or an advertisement banner (not shown) to highlight or promote the existence or use of the research device 10 at a particular store location.

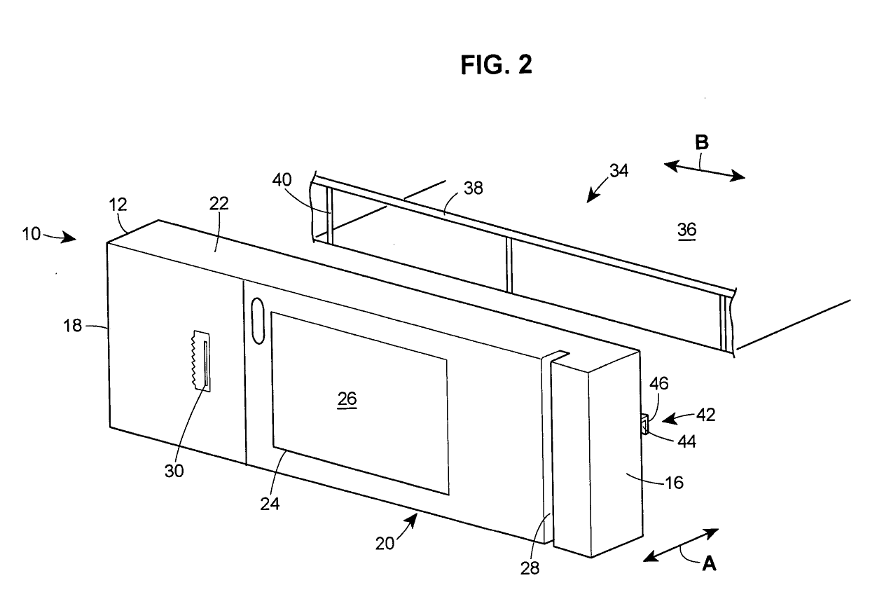

The research device 10 may further include a touch screen 24 adapted to receive an input from a user or consumer (see FIG. 2). It will be understood that the touch screen 24 may be any display device communicatively coupled to a user input device such that user commands and directions are reflected by the graphical user interface on the display device. The touch screen 24 may be a resistive system consisting of a glass panel covered with a conductive layer and a resistive layer separated by a spacer. A scratch-resistant layer may further protect the conductive and resistive layers. In operation, an electrical current may pass through the conductive and resistive layers, and upon user contact the two layers are forced together and cause a change in the electrical field. This change in the electrical field provides a set of coordinates which an operating system may interpret and correlate with a graphical symbol displayed on the touch screen surface 26.

In an alternate embodiment, the touch screen 24 may be a capacitive system that includes an electrical charge storing layer placed in contact with the glass panel of the touch screen surface 26. Upon contact by a user, a portion of the stored electrical charge is transferred to the user such that there is a decrease in the overall capacitance of the charge storing layer. The difference in the capacitance can, in turn, be measured by circuits located at the corners of the touch screen 24 to determine a physical location on the screen.

In another alternate embodiment, the touch screen 24 may be a self contained touch screen computer including, but not limited to, a mother board communicatively connecting a memory and a processor to a touch screen display. In this embodiment, the touch screen 24 such as a FUJITSU FM PenNote portable computer may include an operating system such as WINDOWS™ or LINUX stored on memory and executed by the processor to correlate the input from the touch screen 24 with a program displayed on the touch screen surface 26 or display device (e.g. an LCD). In this way, the touch screen 24 can be a self-contained and “off-the-shelf”device which could include an integral network interface card (NIC), a wireless networking interface, a modem, or any other desired communication interface. For example, the wireless network interface could be an 802.11 a/b/g radio frequency communications system also known as a Wi-Fi system. Further, the modem could be a cellular data modem integrated into the mother board, or any other portion of the research device 10. The cellular modem allows the research device 10 to communicate data without having to provide an in-store infrastructure such as a network.

It will be understood that the research device may incorporate a number of different input devices which would, in turn, allow the touch screen 24 to be replaced with a simple display such as a cathode ray tube (CRT) or liquid crystal display (LCD). Alternate input devices could include a plurality of button or studs position around the display. Further, a trackball or touch pad may be incorporated into the housing 12 to allow the user to manipulate the movement of a pointer or cursor on the display device.

The housing 12 may further include an integral barcode and/or magnetic swipe card reader, collectively referred to as a dual reader 28. In the present embodiment, the dual reader 28 is shown adjacent to the first end 16 extending between the top edge 22 and the bottom edge 20. However, it will be understood that the dual reader 28 can be positioned in any manner allowing for the swiping or reading of a card or a barcode. The dual reader 28 may be replaced or augment with a radio frequency (RF) tag reader capable of reading RF identification tags integrated into loyalty cards, product labels, shopping carts, or any other retail merchandising hardware or advertising material.

The housing 12 may further include a thermal printer 30 positioned adjacent to the second end 18. The thermal printer 30, such as a CITIZEN CMP-10-U5 printer or EPSON MobiLink™ printer, may be utilized to print research results, tallies, research incentives, invitations to additional research conducted via the internet or outside interview facilities, or discount coupons, without the need for ink cartridges and replacements. The thermal printer 30 may be aligned in either a horizontal position (e.g., from the second end 18 to the first end 16), or a vertical position (e.g., from the top edge 22 to the bottom edge 20) depending on the size and desired overall configuration of the research device 10. It will be understood that the thermal printer 30 can be a separate device communicatively coupled to the research device 10 by a wireless communications link. In this manner the overall size of the housing 12 may be reduced which, in turn, decreases the obstruction of the shelf and the products contained thereon.

The housing 12 may include an infrared (IR) port 32 adapted to send and/or receive communications from a remote device. In this manner, a remote terminal such as a Palm OS® device (not shown) can be used to transmit updated instructions, programs, or queries directly to the research device 10 or to receive and download information stored and gathered by the research device 10. The research device 10 can also include WiFi technology such as 802.11 a/b/g compliant devices to allow communication with a WiFi-enabled smart card, handheld, or computing device.

Referring to FIG. 2, a perspective view of the research device 10, including the housing 12, is illustrated adjacent to a shelving unit generally indicated by the numeral 34. The shelving unit 34 includes a perforate shelf surface 36, and a restraining bar 38 fixedly attached to the shelf surface 36 by a vertical portion such as, for example, a plurality of vertical spacers 40. A shelf restraining bracket 42 fixedly attached to a back surface 44 of the housing 12 may be configured to fixedly or removeably attach the research device 10 to the shelving unit 34, an end cap display (not shown), a display table (not shown), or any other desired store location. The present embodiment shows the shelf restraining bracket 42 adapted to engage the restraining bar 38 in a cavity 44 sized to accept the restraining bar 38 and vertical spacers 40. In operation, the shelf restraining bracket 42 prevents movement in the direction indicated by the arrow A by the cooperation of the back surface 44 and a vertical member 46. Further, a plurality of fasteners such as screws, rivets, or wing nuts and locking mechanisms may be attached between the vertical member 46, within the space defined by the restraining bar 38 and the vertical spacers 40, to prevent movement in the direction indicated by the arrow B.

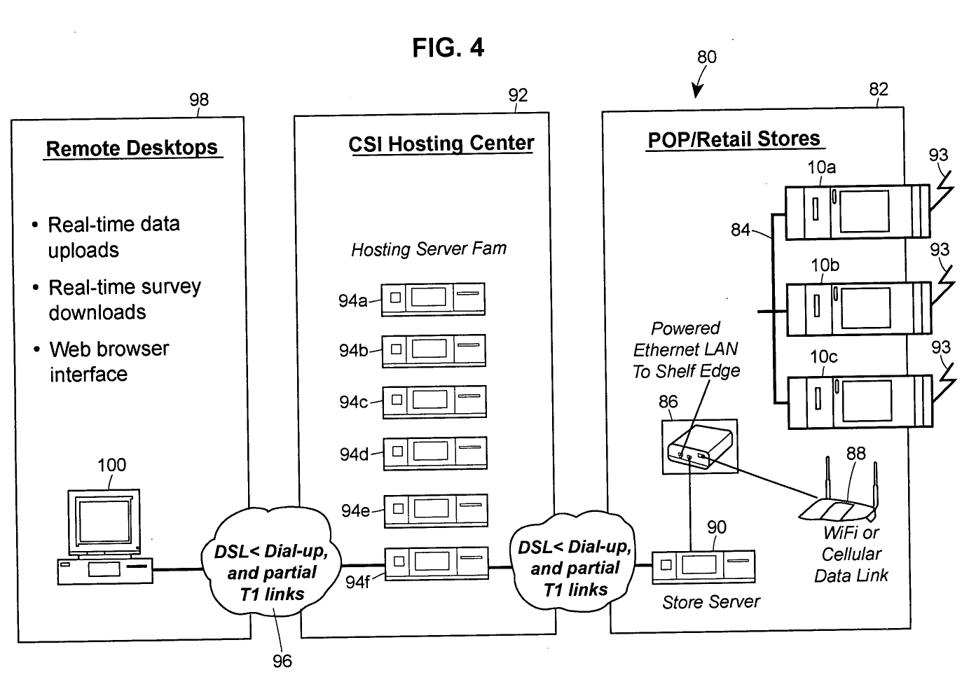

While the exemplary research device 10 is shown mounted adjacent to the shelving unit 34, it will be understood that the research device 10 can mount to virtually any surface in a retail store. In particular, the research device 10 can mount to an end cap display or stand-alone kiosk designed to highlight and display specific products, packaging, etc. Further, the research device 10 can mount to a shopping cart and wirelessly communicate with a server (discussed in depth in FIG. 4) or other research devices 10. In operation, the research device 10 could be activated, for example, by radio frequency identification (RFID) equipment positioned adjacent to the products and packaging to be researched. In this manner, as the consumer moves through the store different products, locations, packaging, etc., can initiate customized research queries to the consumer. Moreover, the research device 10 could include a global positioning system or other navigation devices adapted to correlate the consumer's current position to a store plan-o-gram and initiate customized research queries without the use of RFID or other radio/broadcast markers.

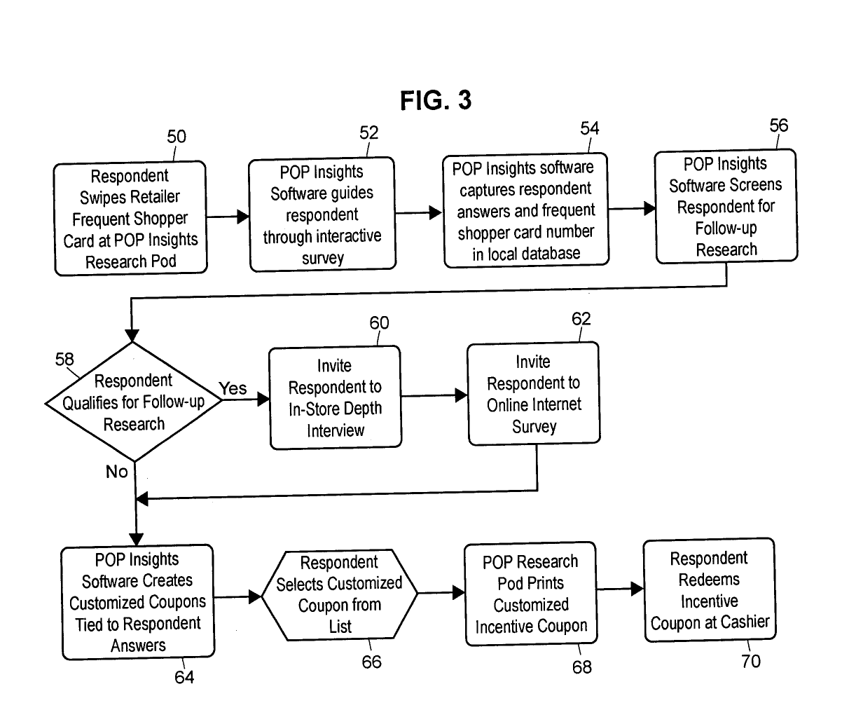

Referring to FIG. 3, an operational flowchart of one embodiment of the research device 10 is illustrated. At a block 50, the consumer may initiate a research session by contacting the touch screen surface 26 or swiping a loyalty card (not shown) through the dual reader 28. The data contained on the loyalty card enables the at-the-shelf preferences (e.g. the point of purchase preferences) to be cross-referenced with the consumers actual purchase transaction history. In addition, the data referenced by the loyalty card typically includes demographics information which may be gathered and correlated without having to ask questions that may cause consumer discomfort or disinterest. In an alternate embodiment, the session may be initiated by the touch screen 24 displaying an advertisement or other attraction message to convince or lure a user to activate the research device 10.

In another alternate embodiment, the consumer may initiate a research session by scanning a product (not shown) using the barcode function of the dual reader 28 to gain additional information stored within the research device 10 on the desired product and then to perform a survey tailored to that specific product. In other words, the research device 10 provides an alternate informational function to the consumer, and in return, the consumer participates in a research session.

In yet another alternate embodiment, the research session may be initiated by the input from a biometric device, such as a finger print reader, incorporated into the research device 10. In this manner, the research device 10 can determine if the consumer participating in the survey is an adult, child, targeted demographic, frequent shopper or any other relevant marketing characteristic. This embodiment may further encompass integrating a web-based camera or webcam into the research device 10. The webcam may be communicatively connected to a central image database and facial biometric recognition software so that an image of the consumer may be captured by the webcam, and correlated with an image in the database by the recognition software. In this way, the research session may be initiated and customized without any active input from the consumer.

At a block 52, the control unit (not shown) within the housing 12, which may be the touch screen computer discussed above, can begin an interactive survey or research session displayable on the touch screen 24. In particular, the control unit can include a processor and a memory wherein the memory stores an interactive survey program and or additional information such as product information, a local database, and any other desired sub-routines. The processor, which may be, for example, a PENTIUM® processor, can execute the stored program to display a series of questions on the touch screen. In one preferred embodiment, the series of questions can be customized based on the user information received from the consumer's frequent shopper's card or extrapolated from the information requested through the dual reader barcode function. In addition, the touch screen 24 may display a progress bar throughout the survey to identify the amount of time remaining. Empirical studies have shown that the use of progress bars increases the survey completion rate. At a block 54, the consumer's responses, loyalty card information, and other gathered information can be stored on a local database which may be integral to the research device 10 or communicatively connected to the research device 10 through the network interface card or other communication means discussed above.

At a block 56, a screening program stored within the control unit memory may be accessed to correlate the captured responses and loyalty card information to determine if the consumer qualifies for follow-up research. The follow-up criteria may be, but are not limited to, age, spending habits, ethnicity, product preferences, or other identified personal characteristics. If the consumer qualifies for follow-up research, at a block 60 the screening program may prompt the user via the touch screen 24 to participate in an in-depth, possibly in-store, interview.

To entice or encourage the consumer to participate with the initial interactive survey, or the in-depth survey, a reward or incentive may be offered. The reward may be, but is not limited to, a discount off their total purchase at the retail store, or a coupon for a product identified through the loyalty card information, the survey responses, or scanned through the card reader 28. In addition, the reward may include a donation to a charity which, in turn, may be selected from a list of participating charities. At a block 62 the consumer may be invited, through an additional question on the touch screen 24, to participate, at a time of their convenience, in an on-line internet survey, telephone survey or an in-person interview. If the internet or interview option is selected, the user may be rewarded with a redemption code or coupons may be mailed directly to the user's address if it is provided, or printed directly from the consumers own printer system.

If at the block 58, the respondent does not qualify for follow-up research, or the respondent at the block 62 decides positively or negatively to participate in additional research surveys or interviews, the research software at a block 64 may create a customized coupon or other reward for the consumer. As discussed above, the customized coupon may be directly tied to a store special, information gathered from the consumer's responses, loyalty card, or based on current “hot”products or trends.

At a block 66, the consumer can select from a list of potential reward options displayed on the touch screen 24. The reward options may include, but are not limited to, cash discounts redeemed via coupons, rewarding the consumer in the form of coupons for the identified products, or as a charitable donation to local or national organizations or other participating or needy group.

At a block 68, the research device 10, including the thermal printer 30, produces the selected reward or coupon based on the consumer's choice stored at the block 66. The consumer, in turn, can directly redeem the coupon during the checkout procedure as shown at a block 70. However, it will be understood that these coupons may have an expiration date or other limiting factor which may allow a user to delay redemption, but would require use within a definite period of time.

Referring to FIG. 4, one possible system level architecture for a multi-research device point-of-purchase research system is generally indicated by the reference numeral 80. A retail site 82, which can be any store or other purchasing location, may include a plurality of research devices generally indicated as 10a, 10b, and 10c. The research devices 10a, 10b, and 10c may be positioned at different physical locations throughout the store. Typically, these locations will be adjacent to products whose packaging, marketing, store signage, store display, or other desirability may wish to be researched or further inquired about. In particular, the research devices 10a, 10b, 10c can be used to identify private labeling opportunities, assess new product introductions, evaluate the highest product pay-off and placement, and optimize store plan-o-grams among other things. The plurality of research devices 10a, 10b, and 10c can be networked or communicatively connected to a local area network (LAN) 84 such as an Ethernet protocol network. The LAN 84 can be a powered LAN that carries low voltage power over a specialized local area network cable to provide both electrical powers and communications to each of the research devices 10a, 10b, and 10c. Further, the plurality of research devices 10a, 10b, and 10c can be communicatively connected using cellular data modems to allow long distance communications between the research devices 10a, 10b, and 10c, and a centralize hosting center (to be described below).

In an alternate embodiment, the research devices 10a, 10b, and 10c may be powered using a solar collector battery, or a fuel cell such as a methanol fuel cell. The solar collector can be solar panel strips mounted on top of the retail store 82 gondolas and wired directly to the research devices 10a, 10b, and 10c. In this manner, the research devices 10a, 10b, and 10c can be powered using renewable and efficient energy sources, thereby reducing the burden on an individual retail store 82. The LAN 84 can, in turn, be communicatively connected to a router 86 and a wireless hub 88. The wireless hub 88 can be used to communicate with alternate remote research devices or a store server 90.

It will be understood that the store server 90 can be adapted to include product information such as nutritional, pricing or locational information for any and all items inventoried at the retail store 82. In addition, the store server 40 can be adapted to include shopper information gathered through retailers' loyalty card programs. Further, the store server 90 may include a remote version of the retail software for execution at the plurality of research devices 10a, 10b, and 10c. The store server 90 may further act as a central database to store the respondent's answers to the research survey, the frequent shopper information, and or the coupon or reward selection information.

In an alternate configuration, the store server 90 may be directly connected to the router 86 and communicatively connected to a hosting center 92 as shown in FIG. 4. The communications link between the store server 90 and the hosting center 92 may be a DSL connection, a simple dial-up connection, or even a T1 link. Further, it will be understood that the communications protocols can be provided by GPRS, 3G, or other cellular data transfer systems. In this way, the plurality of research devices 10a, 10b, 10c can include cellular modems which provide a cellular communications link 93 between the retail site 82 and the hosting center 92, thereby eliminating the need for the store server 90.

The hosting center 92 can include a plurality of servers 94a, 94b, 94c, 94d, 94e, and 94f adapted to act as remote databases to store alternate research or survey questions, to provide a unified location for frequent shopper information, and to provide a centralized source for products updates. Further, the server 94f can be adapted to act as a web server to provide communications between the store server 90 and the internet 96. It will be understood that the web server 94f, or any of the other servers, may be encrypted and include firewall, password protection, or other anti-hacking and security measures.

A research customer site 98 may include a remote desktop 100 adapted to access the internet 96. The remote desktop 100 may, in turn, access the web server 94 to update the information stored on the servers 94a-94f, download survey information, or otherwise analyze the information stored on the servers 94a-94f. The remote desktop 100 can be a customer terminal, a site administrator, or a market research terminal, each of which can analyze or access the stored information in customizable or user specific formats.

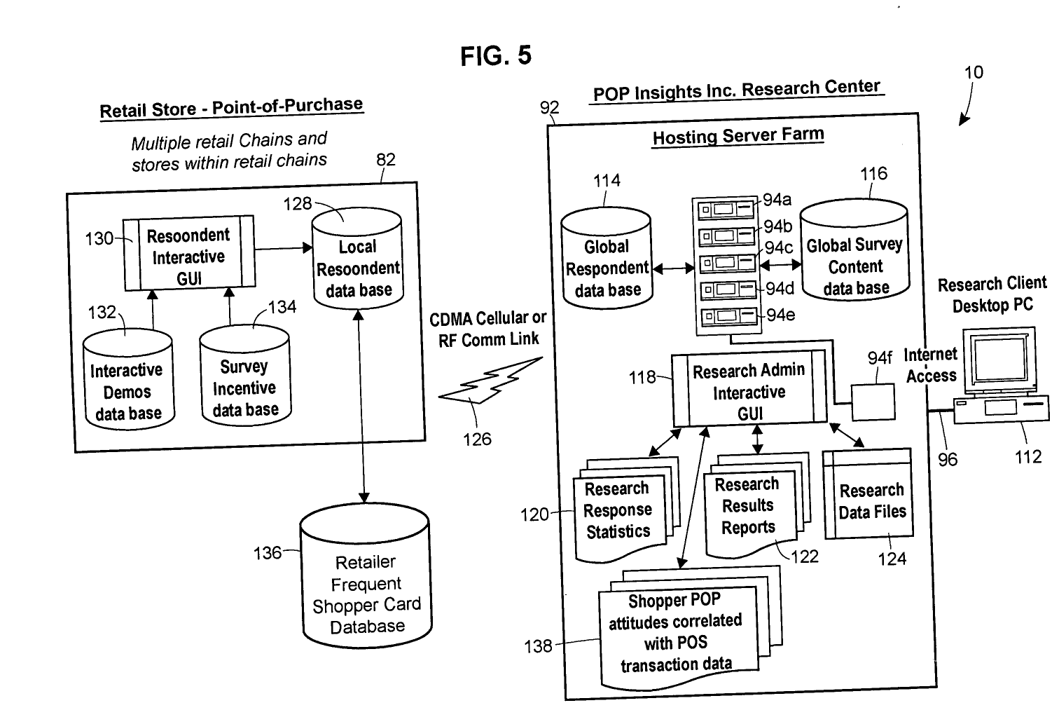

Referring to FIG. 5, a flowchart showing a possible research data flowpath is generally indicated by the reference numeral 110. The research data flowpath could include a research client 112 which can be, but is not limited to, the remote desktop 100 in FIG. 4. The research client 112 can be communicatively connected to the internet 96 and, in turn, the hosting center 92 via the web server 94f. The servers 94a-94f, as previously discussed, can further include a global respondent database 114 containing a comprehensive record of all answers and response gathered through individual research devices 10 at multiple retail stores 82. The servers 94a-94f may further include a global server content database 116 which can be programmed with alternate versions such as surveys differing by demographic information, geographic information, retailer location, or other consumer, manufacturer, or retailer-identified statistics.

The servers 94a-94f may further be programmed and include an interactive research interface 118 to access, parse, analyze the stored respondent and survey information 114, 116, respectively. The research interface 118 can further analyze the stored information to provide research statistics 120, research reports 122, or output specialized data files 124 requested, for example, by a retailer, distributor, or manufacturer. The data files 124 can be output in any format such as a delimited file, a text file, etc. Further, the research interface may be programmed to correlate the stated point-of-purchase (POP) attitudes of a consumer with the realized point of sale (POS) realities of the consumer's buying habits as shown at a block 138. The difference between the professed attitudes and actual buying habits can be thought of as a confidence interval to assess the efficacy of the survey results and gathered information. Furthermore, the combination of actual point-of-sale data and point-of-purchase preferences and attitudes can be used to predict new product, packaging, signage, and display success. As previously discussed, the hosting center 92 can be communicatively connected to the retail store 82 through various communication means such as cellular, or LAN line communications as indicated by the arrow 126.

An alternate retail store 82 may further include a local respondent database 128 and a local research interface 130. The local research interface 130 may be communicatively connected to an interactive demonstration database 132 and a survey rewards database 134. In this way, the local research interface 130, which can be stored on the store server 90, can communicate demonstrations and reward information to the research device 10, or research devices 10a, 10b, and 10c located throughout the retail store. In addition, the local respondent database 128, including local response information and local frequent shopper information, can be communicatively linked to a retailer frequent shopper information database 136. Large retailers may prefer to use proprietary customer information such as the retailer frequent shopper database 136 to administer a proprietary point-of-purchase research system 80. These large retailers may have specific requirements and detailed databases which can be customized to provide specific information relevant to the retailer.

Although certain embodiments have been described in accordance with the teachings of the present disclosure, the scope and coverage of this patent is not limited thereto. On the contrary, this patent is intended to cover all embodiments of the teachings of the disclosure that fairly fall within the scope of the permissible equivalents.

1. A point of purchase research device comprising:
a housing having a user surface and a mounting surface, wherein the mounting surface is adapted to cooperate with a store shelf;
a display device affixed adjacent to the user surface and communicatively connected to a user input device;
a control unit having a processor, wherein the control unit is communicatively connected to the display device and the user input device; and
a control routine executed on the processor and configured to control the display device to gather at least one piece consumer information from the user input device.

2. The research device of claim 1 further comprising a thermal printer.

3. The research device of claim 2, wherein the thermal printer prints a reward in response to the gathered consumer specific information.

4. The research device of claim 1 further comprising a reader adapted to read the at least one piece of consumer information.

5. The research device of claim 4, wherein the reader is a combination barcode and magnetic strip reader.

6. The research device of claim 4, wherein the reader is a radio frequency identification tag reader.

7. The research device of claim 1 further comprising a network interface communicatively connected to the processor.

8. The research device of claim 7, wherein the network interface is a cellular communications device.

9. The research device of claim 7, wherein the network interface is a powered local area network interface to the control unit and display device.

10. The research device of claim 1 further comprising at least one solar cell adapted to provide electrical power and communicatively connected to the display device and the control unit.

11. The research device of claim 1, wherein the control routine is configured to gather consumer specific information by presenting a first question on the display device and receiving an input from the user input device.

12. The research device of claim 11, wherein the control routine is configured to gather consumer specific information by presenting a second question based on the input received in response to the first question.

13. The method of claim 1, wherein the control routine is configured to display a customized advertising message based on gathered consumer information.

14. A point of purchase research system comprising:
at least one research device mountable adjacent to a store shelf, wherein the at least one research device includes:
a display communicatively coupled to a control unit having a processor, wherein the processor executes a control routine configured to interactively gather consumer specific information using a user input device;
a network interface device for connecting the at least one research device to a data network; and
a first database connected to the data network and configured to receive the gathered consumer specific information.

15. The system of claim 14 further comprising a second database communicatively connected to the data network.

16. The system of claim 14, wherein the research device further comprises a reader configured to read the at least one piece of user specific information.

17. The research device of claim 16, wherein the reader is a combination barcode and magnetic strip reader.

18. The research device of claim 16, wherein the reader is a radio frequency identification tag reader.

19. The research device of claim 14 further comprising a thermal printer adapted to provide a reward in response to gathered consumer specific information.

20. The research device of claim 14, wherein the user input device is a plurality of button communicatively connected to the control unit.

21. The research device of claim 14, wherein the user input device is a touchpad or trackball communicatively connected to the control unit.

22. The research device of claim 14 further comprising at least one solar cell adapted to provide electrical power to the at least one research device.

23. The research device of claim 14, wherein the network interface device is a cellular communications device.

24. A method of gathering point of purchase information, the method comprising:
positioning a research device having an integrated display adjacent to a store shelf;
displaying an interactive survey on the integrate display;
gathering user information through responses to the interactive survey;
communicating the responses to a first database through a data network; and
providing a reward in response to the completion of the interactive survey.

25. The method of claim 24, wherein providing the reward includes providing a coupon using a thermal printer integral to the research device.

26. The method of claim 24, wherein gathering the user information further includes gathering consumer information using a reader integrated into the research device.

27. The method of claim 26, wherein displaying the interactive survey includes customizing the interactive survey based on the gathered consumer information.

28. The method of claim 24 further including communicating the responses and consumer information to a second database.

29. The method of claim 24, wherein displaying an interactive survey, includes displaying customized advertising based on gathered consumer information.

30. The method of claim 24 further comprising:
gathering user purchasing information and communicating the user purchasing information to the first database through the data network.

31. The method of claim 30 further comprising:
correlating user purchasing information in the first database with the gathered responses in the first database.

32. A point of purchase research device comprising:
a housing having a mounting portion;
a display device affixed within the housing and communicatively connected to a user input device;
a processor communicatively connected to the display device and the user input device; and
a memory communicatively connected to the processor and adapted to store a control routine configured to gather consumer information from the user input device.

33. The point of purchase device of claim 32, wherein the mounting portion is adapted to secure the housing to a shopping cart.

34. The point of purchase device of claim 32, wherein the mounting portion is adapted to secure the housing to an end cap.

35. The point of purchase device of claim 32, wherein the mounting portion is adapted to secure the housing to a freestanding kiosk.

36. The point of purchase device of claim 32, further comprising a wireless network interface.

37. The point of purchase device of claim 32, wherein the display device is a touchscreen display.

38. The point of purchase device of claim 32, wherein the touchscreen display is a touchscreen computer.
